(19) United States
(12) Patent Application Publication
(10) Pub. No.: US 2012/0116885 A1
(43) Pub. Date: May 10, 2012

(54) SOCIAL NETWORK BASED ONLINE ADVERTISING AND ADVERTISEMENT BRANDING

(75) Inventor: Prabhakaran Krishnamoorthy, Bangalore (IN)

(73) Assignee: Yahoo! Inc., Sunnyvale, CA (US)

(21) Appl. No.: 12/939,932

(22) Filed: Nov. 4, 2010

(51) Int. Cl. G06Q 30/00

(52) U.S. Cl. 705/14.64; 705/14.49

(57) ABSTRACT

Techniques are provided in which positive review, positive comment, or purchase information is obtained, of a first user and relating to a product, service or brand. A second user is identified who is in a social network of the first user. An online advertisement is generated, targeted to a second user, that includes at least one visible feature to allow the second user to recognize the advertisement as relating to a product, service or brand that has been positively commented on, positively reviewed, or purchased by a user in a social network of the first user.

### BACKGROUND

People are naturally very often strongly influenced by the feedback, comments such as opinions, or purchases of others in their social network before, for example, making a purchase. For example, an individual knowing that a family member or friend has commented positively on a certain brand of a product, or recently bought a certain brand of a product, may well positively influence the chances that the individual will make a similar purchase.

There is a need for techniques in online advertising relating to, among other things, use, or optimal use, of review, comment or purchase information, or other social networking information.

### SUMMARY

Some embodiments of the invention provide systems and methods in which review, comment (which can include opinion), or purchase information is obtained, the information being associated with a first user and relating to a product or service, product or service type, or brand. A second user is identified who is in an explicit or implicit social network of the first user. An online advertisement is generated, targeted to a second user and relating to the first product or service, product or service type, or brand. The online advertisement is generated utilizing the review, comment, or purchase information, which may serve as a trusted implicit or explicit recommendation regarding a subject of the advertisement.

Some embodiments of the invention provide techniques in which positive review, positive comment, or purchase information is obtained, of a first user and relating to a product, service or brand. A second user is identified who is in a social network of the first user. An online advertisement is generated, targeted to a second user, that includes at least one visible feature to allow the second user to recognize the advertisement as relating to a product, service or brand that has been positively commented on, positively reviewed, or purchased by a user in a social network of the first user.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a block diagram illustrating one embodiment of the invention; and

FIG. 5 is a block diagram illustrating one embodiment of the invention.

FIG. 6 is a flow diagram illustrating a method according to one embodiment of the invention;

FIG. 7 is a flow diagram illustrating a method according to one embodiment of the invention; and

FIG. 8 is a block diagram illustrating one embodiment of the invention.

While the invention is described with reference to the above drawings, the drawings are intended to be illustrative, and the invention contemplates other embodiments within the spirit of the invention.

### DETAILED DESCRIPTION

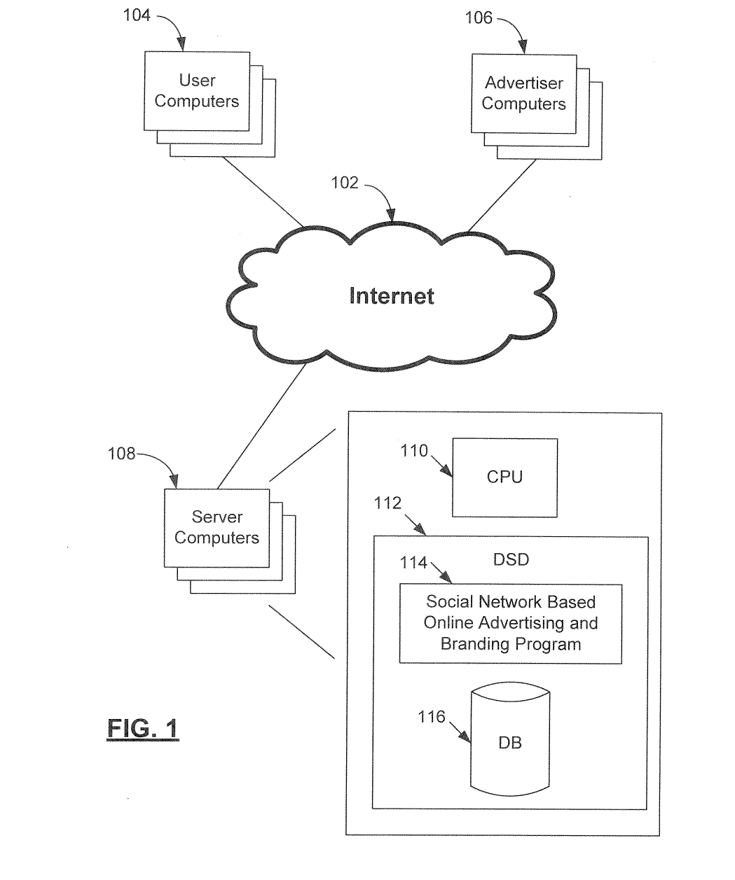

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, PDAs, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and a Social Network Based Online Advertising and Branding Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

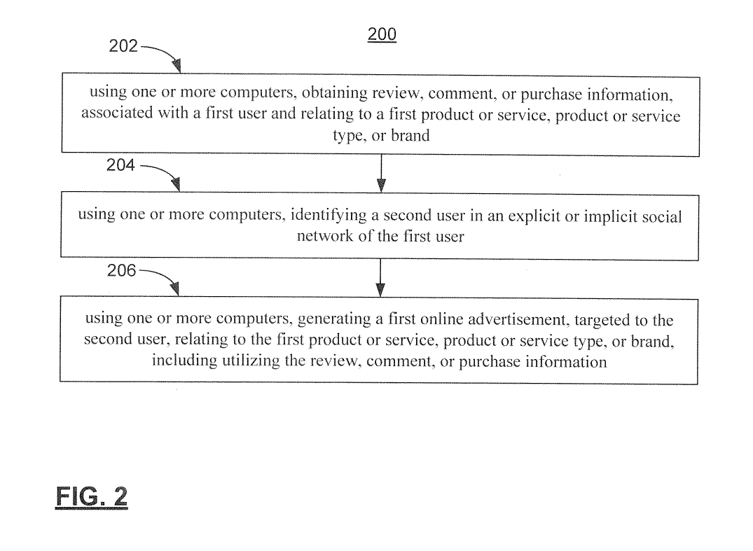

FIG. 2 is a flow diagram illustrating a method 200 according to one embodiment of the invention. At step 202, using one or more computers, review, comment, or purchase information is obtained, associated with a first user and relating to a first product or service, product or service type, or brand.

At step 204, using one or more computers, a second user is identified, in an explicit or implicit social network of the first user.

At step 206, using one or more computers, a first online advertisement is generated, targeted to the second user and relating to the first product or service, product or service type, or brand, including utilizing the review, comment, or purchase information.

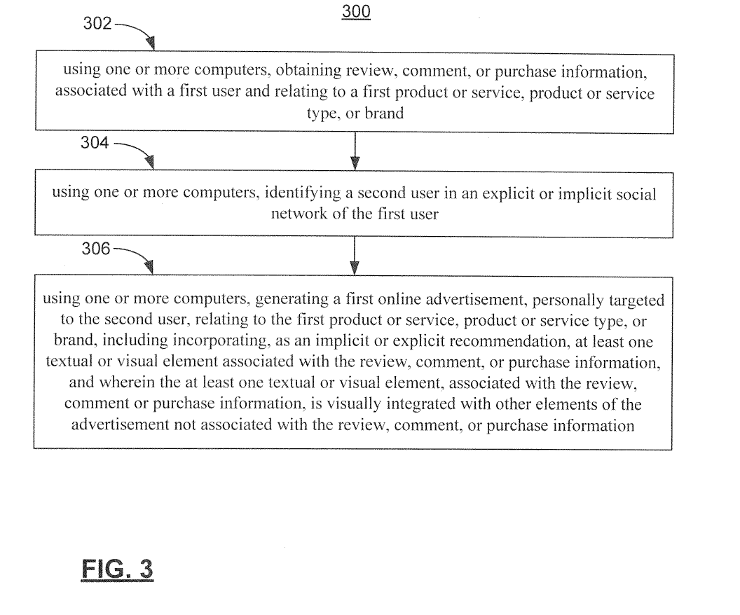

FIG. 3 is a flow diagram illustrating a method 300 according to one embodiment of the invention. At step 302, using one or more computers, review, comment, or purchase information is obtained, associated with a first user and relating to a first product or service, product or service type, or brand.

At step 304, using one or more computers, a second user is identified, in an explicit or implicit social network of the first user.

At step 306, using one or more computers, a first online advertisement is generated, personally targeted to the second user, relating to the first product or service, product or service type, or brand. Generating the first online advertisement includes incorporating, as an implicit or explicit recommendation, at least one textual or visual element associated with the review, comment, or purchase information. The at least one textual or visual element, associated with the review, comment or purchase information, is visually integrated with other elements of the advertisement not associated with the review, comment, or purchase information.

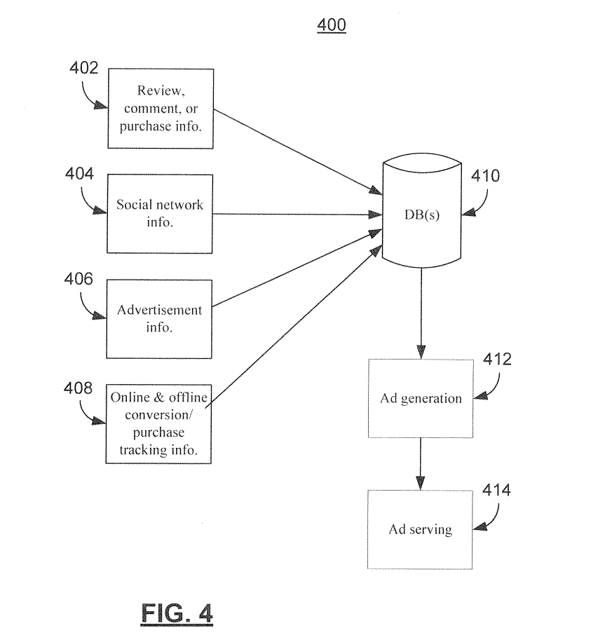

FIG. 4 is a block diagram 400 illustrating one embodiment of the invention. One or more data stores or databases 410 are depicted. Various types of information are stored in the database 410, which information may be obtained, gathered, or generated in various ways. In particular, types of depicted information stored in the database 410 include review (including opinion), comment, or purchase information 402, social network information 404, advertisement information 406, and online and offline conversion and purchase tracking information 408. As depicted at block 412, all these types of information, possibly among other types, is used in online advertisement generation 412, for serving 414 to a user.

Specifically, review, comment, or purchase information, relating to a particular user and a particular product or service, product or service type, or brand is obtained. Social network information is used to identify another user in a social network of the particular user. Review, comment, or purchase information may be combined or otherwise incorporated or integrated, perhaps after processing or re-formatting, with other advertisement information to generate an advertisement targeted to the other user, which may relate to the particular product or service, type of product or service, or brand, or something related or otherwise associated with the particular product or service, type of product or service, or brand. The generated advertisement is served to the other user. The incorporated or integrated review, comment, or purchase information may serve as a trusted implicit or explicit recommendation or enticement to the other user, by a person in a social network of the other user, to perform in some way solicited by the advertisement, such as by performing a particular online or offline conversion or purchase, or even simply clicking or selecting through the advertisement.

Furthermore, click, conversion or purchase information, for example, relating to the other user in connection with the advertisement, may be tracked, and used for any of various purposes, such as purposes in connection with an advertising campaign or determining metrics related to an advertising campaign. For example, tracked information can be used in assessing, determining, estimating, optimizing, or forecasting various online or offline advertising or advertising campaign parameters such as advertisement performance, value, or pricing.

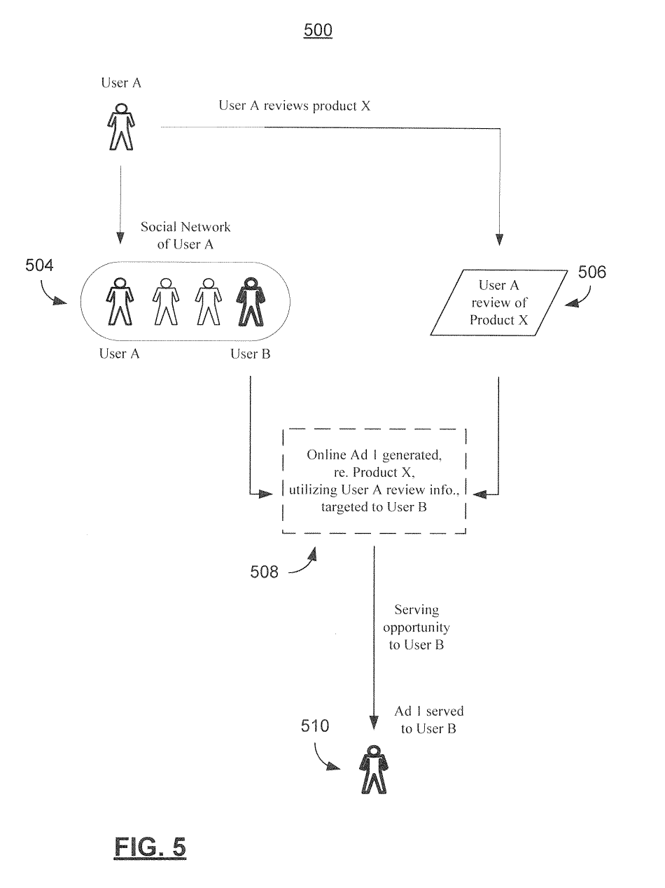

FIG. 5 is a block diagram 500 illustrating one embodiment of the invention. An online user, User A is depicted. User A posts or otherwise generates a review 506 of a certain product or brand, such as product X. User A is determined to be in one or more social networks with numerous other users, such as User B. Using social network information associating User A and User B, the review information posted by User A, and potentially various other types of information, such as product or advertisement information relating to product X or a related product or brand, potentially among other information, an online advertisement, Ad 1, is generated, as represented by block 508.

Ad 1 may be personally targeted to User B, and may incorporate or integrate elements of the review, as well as identify or reference User A, possibly including an indication of the relationship, association, or social network association between User A with user B, for instance. Furthermore, Ad 1 may include various personal, personal identity or biographical related information or elements relating to User A, such as user A's name, address, a picture, audio clip or video clip from or including User A, etc. Ad 1 may include one or more elements, such as textual, visual, graphical, video, or audio elements, that are integrated to include review information as well as other information, such as advertisement information relating to product X. When an appropriate serving opportunity arises, Ad 1 is served to User B.

Furthermore, in some embodiments, multiple reviews (or comments, purchase information, etc.) on a product or service, type of product or service, or brand can be collected from different users, each of whom may be associated with or in a social network of the targeted user. In some embodiments, for example, reviews from multiple users in a social network of a particular user may be aggregated. Elements from each of the reviews, and possibly also personal identity-related information or elements relating to each of the multiple reviewing users, can be incorporated in an advertisement targeted to the particular user.

Some embodiments of the invention provide methods and systems for use in online advertising, including targeted online advertising. Some embodiments include generating, or facilitating generation of, targeted advertisements using product reviews, opinions or comments, or using previous online or offline purchase information. Positive review information or purchase information may be used in facilitating targeted advertising. The information may be used in generating advertisements or advertisement content targeted to other users known to or in a social network of the reviewer or purchaser. Review or purchase information, as well as reviewer or purchaser identifying or referencing information, can be included in an advertisement targeted to an online user in the reviewer's or purchaser's social network, or otherwise known or associated with the reviewer or purchaser.

The advertisement can also include, for example, advertising information relating to a product that is the same or similar to the product reviewed or purchased by the reviewer or purchaser. The targeted user may be enticed to buy the product, or service, in part by the personalized and positive direct or indirect endorsement or recommendation effect of including the review or purchase information relating to the person in the targeted user's social network. Furthermore, the review or purchase information can be tied in, through content, visually, or both, with the product information and advertisement information. An integrated advertisement can be provided to catch the targeted user's attention with positive endorsement information from a person who may be known to the targeted user, naturally channeling the targeted user's attention to the advertisement information. This can lead to greater user interest or positivity, and can increase probability of click through, purchase or other conversion, for example.

In some embodiments, Web sites are crawled, analyzed, or otherwise reviewed to obtain online review and comment information on a product or type of product, such as by crawling Web sites for relevant content. Online purchase information may be obtained, for example, from seller databases or other databases including online purchase history information. Offline purchase or review information may be obtained by various means, including phone or mail surveys, or information provided from offline stores, such as purchase history information. Obtained online or offline review or purchase information can be used in generation of a targeted advertisement to a user in a social network of the reviewing or purchasing user or person.

In some embodiments, purchase information may be obtained through arrangements with entities that have such information, such as arrangements with banks, shopping malls, online retailers, online purchase and payment facilitators, etc.

In some embodiments, arrangements can be made with users, in which pre-formulated potential reviews are provided to the user. The user may be able to select or edit the potential reviews, choosing or generating an actual review. The actual review can be used in advertisements targeted to users in the reviewer's social network. The reviewer could be compensated for participation in any of various ways, including being provided with content, online or offline discounts, etc.

In some embodiments, advertisements can be generated from review or purchase information and reviewer and purchaser identity or social network relationship information, or can be supplemented or augmented with such information. The advertisement can be textual, visual, video, etc.

In some embodiments, reviewers and purchasers benefit at least from helping friends or others in their social networks, if not in other ways. Sellers, advertisers, publishers, advertising marketplace entities, and other entities benefit, for example, from increased probability of click or conversion and increased revenue.

In some embodiments, a premium can be charged, or otherwise worked into pricing or bidding, etc, to advertisers for the service of providing or facilitating such advertisements, since with advertisements may present a higher probability of conversion than more general advertisements. In some embodiments, pricing or bidding in a marketplace, such as an auction-based online advertising marketplace, can be based on, or partially based on, increased value of advertisements according to embodiments of the invention. In some embodiments, tracked conversion information can be used in determining such value or enhanced value.

Some embodiments of the invention contemplate arrangements in which users agree to, or even request, certain types of advertisement, advertisements in certain areas, or advertisements filtered in other ways. For example, in some embodiments, users may request or indicate a preference for advertisements associated with people in a social network of the user. Some embodiments contemplate providing advertisements in connection with such situations or arrangements, using information stored in one or more databases, including, for example, social network and advertisement information. Furthermore, information stored in data stores or databases according to embodiments of the invention can be mined or used in other ways or for other purposes.

Some embodiments of the invention contemplate sophisticated and integrated usage of both online and offline information, include usage in connection with integrated online and offline advertisement campaigns. For example, in some embodiments, both online and offline conversions or purchases, or other behavior, may be tracked and associated with particular advertisements, impressions, etc. Still further, in some embodiments, controlled experiments are used in this and other regards. For example, in some embodiments, behavior is tracked of a control group who have not received an advertisement, even though they meet any associated targeting criteria and otherwise would have received the advertisement, and of an experimental group who actually were shown the advertisement. Tracking of behavior of both groups, potentially both online and offline, and comparing them, can lead to inferences and metrics regarding the effectiveness or performance of the advertisement, such as conversion rate, etc. This, in turn, can be used in advertising campaign operations and optimization, for example.

Some embodiments include detecting buyers and collecting review information from social networking platforms. In some embodiments, reviews are structured to create or add to advertisements. Text or display advertisements, for example, can then be served to relatives or friends of the buyer and reviewer of a product, service or brand.

In some embodiments, purchase information itself can be converted into or used in an advertisement which is shown to people in the purchaser's network or networks, which can include obtaining permission from the buyer. In some such embodiments, no review information is needed.

In some embodiments, permission is obtained from a reviewer or purchaser before including review or purchase information, and possibly also personal identity information relating to the reviewer or purchaser, in advertisements. In some embodiments, it is not necessary to obtain permission many times. Instead, for example, general permission may be obtained only once to cover multiple occasions of usage. For example, one-time type permission could be obtained from a user to cover multiple instances, such as multiple instances of a certain kind of purchases over a specified period. After such permission is obtained, each time the user makes a purchase or generates a review, covered by the one-time permission, advertisements can be generated using the review or purchase information without obtaining permission from the user each time, increasing efficiency and saving system resources.

Some embodiments of the invention include offline advertising (such as newspaper or other print advertising, etc.) in addition to or instead of online advertising. For example, in some embodiments, advertisements generated using reviews or purchase information can be included in offline advertisements in newspapers, magazines, or in posting mailings to people, such as in association with coupons or promotions, etc.

Some embodiments include a recognition that, frequently, one takes suggestions from relatives or friends in deciding to, for example, buy a product of some brand, which can range from purchasing car, to going to a movie screening, etc. Positive feedback on a particular product may well tilt a buyer in favor of the particular brand, for example. As such, an advertiser can benefit by targeting an advertisement to some prospective buyer who is related to a satisfied customer, for example, which may be much more effective than a more general advertisement.

Furthermore, some embodiments include using purchase information in an advertisement. In many cases, purchase information itself can certainly influence relatives or friends to buy a product, for example.

Some embodiments include detecting buyers. In some embodiments, this can be done by arrangements, for example, with banks relating to credit card statements, with shopping malls, by tracking online purchases, for example, through Yahoo! Shopping or a product manufacturer's registration or feed, etc., all potentially with any necessary or appropriate permissions or authorizations. In some embodiments, conversions or purchases following exposure to an advertisement can also be tracked using similar arrangements.

Some embodiments include collecting reviews, both online and offline. For example, in some embodiments, buyers may be contact to get the review information, whether online, through email, “snailmail”, phone etc. Furthermore, some embodiments include various automated ways to collect review information, such as by crawling review sites, blogs, social networking sites, etc. to get the review and reviewer information.

Various techniques are contemplated in relation to generating advertisements. For example, in some embodiments, a whole review may be used as or re-formatted as an advertisement. In some embodiments, positive or interesting points only from a review are selected and used in or converted to an advertisement.

In some embodiments, a reviewer or buyer may have indicated, or may provide, a score relating to product satisfaction, recommendation, etc. In some embodiments, such a score may be used in or converted into an advertisement, or may be incorporated and integrated into an overall advertisement, for example.

Various techniques are contemplated in identifying people in social networks, etc. For example, in some embodiments, persons related or associated with a reviewer are determined from a social networking site, email address books or other information, chats, etc.

Various techniques are contemplated regarding associating or tracking conversions, purchases, or other behavior, in connection with presented advertisements. As just one simple example, if a user displayed an advertisement for a product purchases that product within a certain time frame from display of the advertisement, or from clicking on the advertisement, etc., that purchase may be attributed to the advertisement. Many other techniques are contemplated.

Some embodiments provide highly personalized advertisements. Furthermore, a known person's implicit or explicit recommendation can serve as an effective advertisement or endorsement. The potential buyer may get the benefit of, for example, a first-hand, trusted recommendation, which buyers often look for. Furthermore, in some embodiments, since the advertiser benefits in this scenario, the advertiser may pass some benefit onto the reviewing user, helping to motivate and reward the reviewing user for any participation or permissions. Furthermore, in some embodiments, various incentives can be provided to users in connection with providing reviews to be used in generating advertisements, whether the incentives are offered by an advertiser or otherwise. For example, in some embodiments, users, without making a purchase, can be provided with benefit such as free samples of a product or service, in return for which (or just based at least in part on the incentive or good will generated from being provided with the free samples), the users provide reviews or comments that can be used in advertisements.

Some embodiments also recognize that service providers or online portals benefit, obtaining more revenue by effectively monetizing in the social networking space. Furthermore, in some embodiments, advertisements including reviews, for example, can be priced at a premium to advertisers, given their higher anticipated or proven performance. Still further, various information collected and stored in databases according to embodiments can be mined and used in various other ways, such as for various means of monetization, user targeting, statistical information collection and analysis, etc.

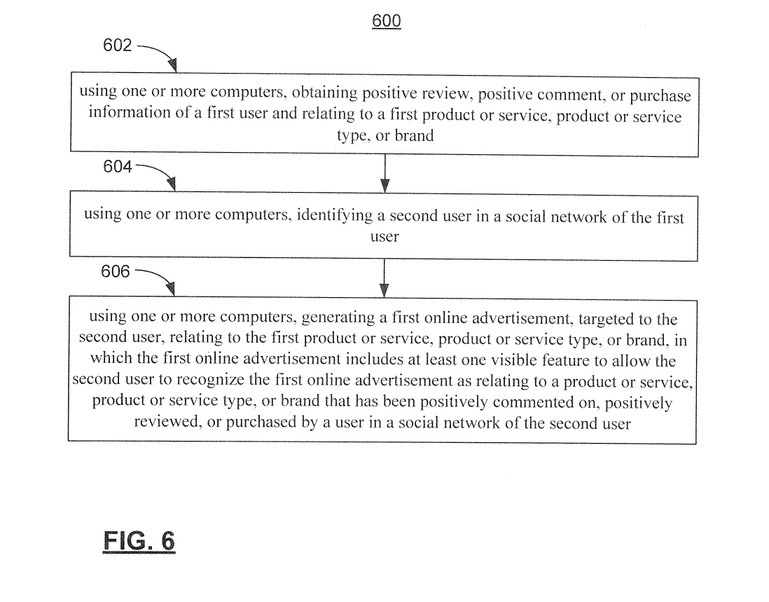

FIG. 6 is a flow diagram illustrating a method 600 according to one embodiment of the invention. At step 602, using one or more computers, positive review, positive comment, or purchase information is obtained, of a first user and relating to a first product or service, product or service type, or brand.

At step 604, using one or more computers, a second user in a social network of the first user is identified.

At step 606, using one or more computers, a first online advertisement is generated, targeted to the second user, and relating to the first product or service, product or service type, or brand. The first online advertisement includes at least one visible feature to allow the second user to recognize the first online advertisement as relating to a product or service, product or service type, or brand that has been positively commented on, positively reviewed, or purchased by a user in a social network of the second user.

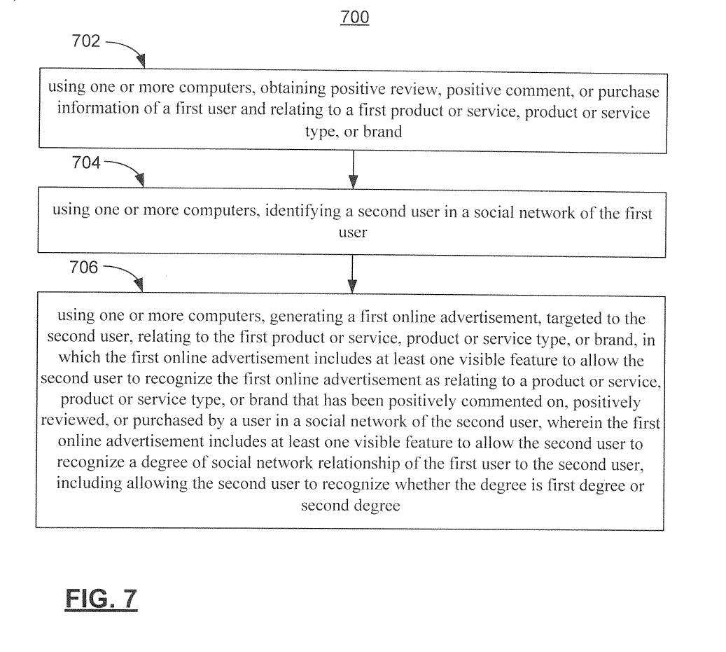

FIG. 7 is a flow diagram illustrating a method 700 according to one embodiment of the invention. Steps 702 and 704 are similar to steps 602 and 604 of FIG. 6.

At step 706, using one or more computers, a first online advertisement is generated, targeted to the second user, and relating to the first product or service, product or service type, or brand. The first online advertisement includes at least one visible feature to allow the second user to recognize the first online advertisement as relating to a product or service, product or service type, or brand that has been positively commented on, positively reviewed, or purchased by a user in a social network of the second user, and includes at least one visible feature to allow the second user to recognize a degree of social network relationship of the first user to the second user, including allowing the second user to recognize whether the degree is first degree or second degree.

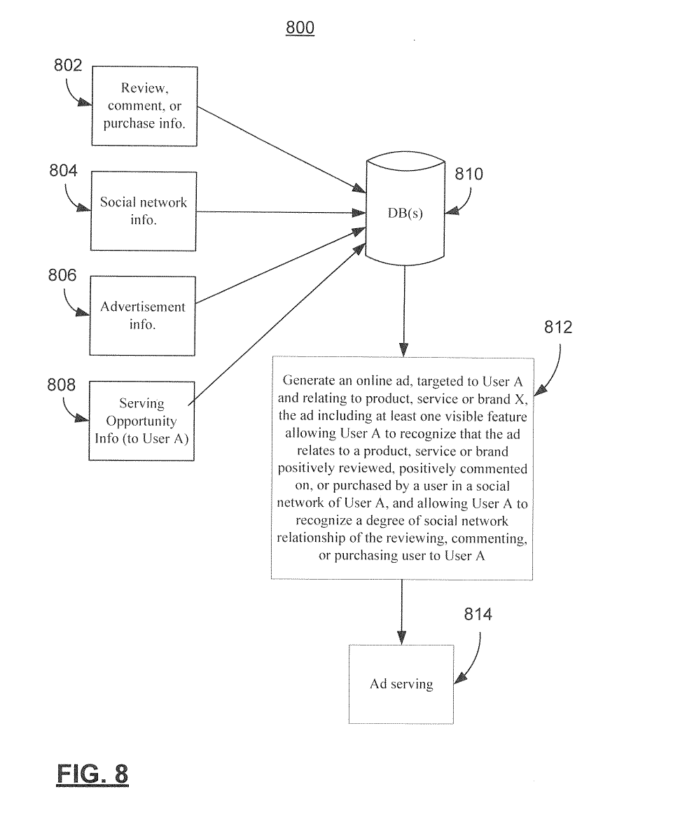

FIG. 8 is a block diagram 800 illustrating one embodiment of the invention. One or more data stores or databases 810 are depicted. Various types of information are stored in the database 810, which information may be obtained, gathered, or generated in various ways. In particular, types of depicted information stored in the database 810 include, potentially among many other types of information, review (including opinion), comment, or purchase information 802, social network information 804, advertisement information 806, and information relating to a serving opportunity 408. The serving opportunity relates to an opportunity to serve an advertisement to a particular user, User A.

Block 812 represents generation of an online advertisement, targeted to User A and relating to product, service or brand X. The advertisement includes at least one visible feature allowing User A to recognize that the advertisement relates to a product, service or brand positively reviewed, positively commented on, or purchased by a user in a social network of User A, and allowing User A to recognize a degree of social network relationship of the reviewing, commenting, or purchasing user to User A.

Some embodiments of the invention provide techniques that can increase online advertisement performance and user engagement, for example, increasing click through rate, conversion rate, etc. Some embodiments of the invention recognize that endorsement by fellow social network member can greatly increase user interest in an advertisement, and positive perception of a product being advertised, etc.

Some embodiments provide an advertisement that may be or are recognizable by the targeted user as advertising a product that has been endorsed (such as positively reviewed, positively commented on, or purchased) by another user in a social network of the targeted user. In some embodiments, for example, the size, shape, color, or some other visible attribute of the advertisement may allow such recognition.

Furthermore, in some embodiments, visible features may allow recognition of a degree of connection or relationship of the endorsing user to the targeted user. Various definitions of degrees of relationship are possible. For example, in some embodiments, a first degree relationship could indicate endorsement by any user to which the targeted user is directed connected, a second degree relationship could indicate a user to whom the targeted user is connected through one intermediary user, etc. In other embodiments, the nature of the connection could be a factor or the defining factor, such as if a first degree relationship means a family member of the targeted user, or a family member or personal friend, etc.

In some embodiments, an advertisement may be immediately or quickly recognizable by the targeted user as being endorsed by a fellow social network member, and may also indicate the degree of the relationship. For example, an advertisement including a first degree endorsement could be standardized to have a blue outer color and be star-shaped, an advertisement including a second degree endorsement could have a yellow outer color and be oval-shaped, etc. In some embodiments, the key for such meaning could be explicit, but in other embodiments, targeted users may simply pick up the meaning of the visible features over time and repeated exposure.

In some embodiments, visible indicators of endorsement can be used when particular endorser information, such as identity, photo, specific commentary, etc., is unavailable, withheld due to privacy concerns, or otherwise chosen not to be included. However, in some embodiments, such specific information can also be provided along with visible indicators or endorsement, or can be provided if a targeted user clicks on an advertisement, etc.

In some embodiments, a targeted user can immediately recognize endorsement by a social network member, and perhaps degree of endorsement, even while the identity of the endorser is not known or provided. Furthermore, the immediacy of the recognition, which may not even require reading the advertisement, could play a large role in increasing advertisement performance, which grabbing the attention of the targeted user very rapidly can be very important.

In various embodiments, a visible indication of endorsement could mean endorsement by a user in an explicit social network of the targeted user, an implicit social network of the targeted user, one or more particular social networks of the targeted user, etc. For example, in some embodiments, a visible indication of endorsement could specifically indicate endorsement by a member of a particular social network, which could include Web-based social networks and social network-associated systems, such as Facebook, Linkedin, Myspace, Orkut, Yahoo Mail, Gmail, Hotmail, etc. In some embodiments, for example, visible tags may be included as part of the advertisement, which tag or tags may provide an indication of the particular network or networks.

Furthermore, in some embodiments, a visible indication, such as one or more tags, could be included to indicate a characteristic like the closeness of the endorsing user to the targeted user. For example, such closeness could be determined or derived from information such as number, frequency, recency, nature or duration of communications or messaging, such as chat, social updates, etc. Still further, in some embodiments, based on the closeness, a visible indication could be provided to the targeted user, such as “very close person”, etc., or even a score, or the like, providing an indication of degree of closeness.

In some embodiments, branded advertisements (including advertisements according to embodiments of the invention including visible indications of endorsement) could be displayed or consistently displayed in a particular area, portion, position or location of a display, which could provide an indication, or an additional indication, to the viewing user that the advertisement is a branded advertisement, etc.

In various embodiments, any of various entities could be responsible for determining and/or verifying advertisement branding information and characteristics, and visible indications of such. For example, such an entity could include at least one of an advertising facilitator entity, a publisher, or an advertiser.

In some embodiments, a visible indication of endorsement could mean positive commentary, positive review, or purchase, but many other variations are contemplated. For example, endorsement could mean only positive commentary or review, or could mean only purchase, etc.

In some ways, some embodiments of the invention can be viewed as providing branding, but rather than with respect to a product origin or company, branding with respect to social network endorsement.

While the invention is described with reference to the above drawings, the drawings are intended to be illustrative, and the invention contemplates other embodiments within the spirit of the invention.

1. A method comprising:
using one or more computers, obtaining positive review, positive comment, or purchase information of a first user and relating to a first product or service, product or service type, or brand;
using one or more computers, identifying a second user in a social network of the first user; and
using one or more computers, generating a first online advertisement, targeted to the second user, relating to the first product or service, product or service type, or brand, wherein the first online advertisement includes at least one visible feature to allow the second user to recognize the first online advertisement as relating to a product or service, product or service type, or brand that has been positively commented on, positively reviewed, or purchased by a user in a social network of the second user.

2. The method of claim 1, comprising identifying a second user in an explicit or implicit social network of the first user.

3. The method of claim 1, comprising facilitating serving of the first advertisement to the second user.

4. The method of claim 1, comprising facilitating serving of the first advertisement to a mobile device of the second user.

5. The method of claim 1, comprising generating the first online advertisement, wherein the first online advertisement includes a visible indication of one or more particular social networks associated with the first user.

6. The method of claim 1, comprising generating the first online advertisement, wherein the first online advertisement includes a visible indication of a degree of closeness of the first user to the second user.

7. The method of claim 1, comprising facilitating display of branded advertisements in a display position or display location that is associated with display of branded advertisements.

8. The method of claim 1, comprising generating the first online advertisement, wherein an entity responsible at least in part for determining or verifying branding information associated with the first online advertisement includes an advertising facilitator entity, a publisher, or an advertiser.

9. The method of claim 1, comprising generating the first online advertisement, wherein the at least one visible feature includes a size, shape, color, or graphical feature.

10. The method of claim 1, comprising generating the first online advertisement, wherein the at least one visible feature includes a thematic feature.

11. The method of claim 1, comprising generating the first online advertisement, wherein the at least one visible feature includes a rich media feature.

12. The method of claim 1, comprising generating the first online advertisement, wherein the first online advertisement includes at least one visible feature to allow the second user to recognize the first online advertisement as relating to a product or service, product or service type, or brand that has been positively commented on, positively reviewed, or purchased by a user in a social network of the second user; and
wherein the first online advertisement includes at least one visible feature to allow the second user to recognize a degree of social network relationship of the first user to the second user.

13. The method of claim 1, comprising generating the first online advertisement, wherein the first online advertisement includes at least one visible feature to allow the second user to recognize the first online advertisement as relating to a product or service, product or service type, or brand that has been positively commented on, positively reviewed, or purchased by a user in a social network of the second user;
wherein the first online advertisement includes at least one visible feature to allow the second user to recognize a degree of social network relationship of the first user to the second user, including allowing the second user to recognize whether the degree is first degree or second degree.

14. A system comprising:
one or more server computers coupled to a network; and
one or more databases coupled to the one or more server computers;
wherein the one or more server computers are for:
obtaining positive review, positive comment, or purchase information of a first user and relating to a first product or service, product or service type, or brand;
identifying a second user in a social network of the first user; and
generating a first online advertisement, targeted to the second user, relating to the first product or service, product or service type, or brand, wherein the first online advertisement includes at least one visible feature to allow the second user to recognize the first online advertisement as relating to a product or service, product or service type, or brand that has been positively commented on, positively reviewed, or purchased by a user in a social network of the second user.

15. The system of claim 14, comprising obtaining and storing positive review, positive comment, or purchase information of a first user and relating to a first product or service, product or service type, or brand.

16. The system of claim 14, comprising facilitating serving of the first advertisement to the second user.

17. The system of claim 14, comprising serving of the first advertisement to the second user.

18. The system of claim 14, wherein the first online advertisement includes at least one visible feature to allow the second user to recognize a degree of social network relationship of the first user to the second user.

19. The system of claim 14, wherein the first online advertisement includes at least one visible feature to allow the second user to recognize a degree of social network relationship of the first user to the second user, including allowing the second user to recognize whether the degree is first degree or second degree.

20. A computer readable medium or media containing instructions for executing a method comprising:
using one or more computers, obtaining positive review, positive comment, or purchase information of a first user and relating to a first product or service, product or service type, or brand;
using one or more computers, identifying a second user in a social network of the first user; and
using one or more computers, generating a first online advertisement, targeted to the second user, relating to the first product or service, product or service type, or brand, wherein the first online advertisement includes at least one visible feature to allow the second user to recognize the first online advertisement as relating to a product or service, product or service type, or brand that has been positively commented on, positively reviewed, or purchased by a user in a social network of the second user;
wherein the first online advertisement includes at least one visible feature to allow the second user to recognize a degree of social network relationship of the first user to the second user, including allowing the second user to recognize whether the degree is first degree or second degree.
